(19) United States
(12) Patent Application Publication
(10) Pub. No.: US 2005/0102500 A1
(43) Pub. Date: May 12, 2005

(54) System and method for integrating applications in different enterprises separated by firewalls

(75) Inventors: Manoj Khangaonkar, Foster City, CA (US); Adwait Sathye, Sunnyvale, CA (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 10/712,665

(22) Filed: Nov. 12, 2003

(51) Int. Cl. H04L 9/00

(52) U.S. Cl. 713/153

(57) ABSTRACT

A system for integrating applications in different enterprises separated by firewalls comprises: an input for receiving high level business data from a source application; an encryption engine for encrypting the business data to produce encrypted business data; a queue manager for receiving the encrypted business data and for storing the business data for delivery to a target application; and an output for transmitting the encrypted business data to the target application; wherein the system and the target application are separated by at least one firewall.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of information technologies and more particularly relates to the field of business process integration.

### BACKGROUND OF THE INVENTION

In the past enterprises have devoted substantial resources to implement custom, standalone information systems that address specific business domain functionality requirements such as accounting, payroll, manufacturing, and distribution. By creating these separate, standalone systems, each individual section of the business process became isolated from the others.

Over time, corporate Information Technology (IT) departments have shifted away from in-house development of these custom systems and have attempted to minimize costs by purchasing enterprise applications from various software vendors. Enterprise applications are more generic, providing general business functionality in a pre-packaged product. Typically, enterprise applications include heterogeneous combinations of application systems, hardware platforms, operating systems, third- and fourth-generation languages, databases, network protocols, and management tools. While these applications bring tremendous benefits to the companies that implement them, on an enterprise level, they only exacerbate the proliferation of “process islands” because they are not readily integratable.

The need for seamless integration of enterprise applications has resulted in the development of various enterprise application integration (EAI) systems. One such EAI system was a hub-and-spoke system developed by CrossWorlds, Inc. (now part of International Business Machines Corporation) that employs a distributed application with agent and server processes sending messages to each other over a network. Further improvements to that system may be required for deployment over a wide-area network (WAN) such as the Internet due to reliability and security issues. One solution is to use HTTP (HyperText Transfer Protocol) as the transport mechanism but further improvement is desirable to enhance security and reliability.

The Internet has become an important communication medium for business information. The existing infrastructure is far-reaching and its protocol is universally accepted and used. However, a compatibility problem still exists because different nodes in the Internet use different applications programs that use different data structures and different semantics. Moreover, nodes comprising LANs typically use firewalls to separate those LANs from the Internet. Presently communication across enterprise firewalls presents a problem for business process communications among applications in different enterprises. Conventional infrastructures are adequate for business data communication within a LAN but are inadequate for wide area networks. The inadequacy arises from reliability and security concerns. Therefore, there is a need for a business process integration system that provides secure and reliable inter-enterprise communications.

IBM's MQSeries software is messaging middleware that allows programs to communicate with each other across all IBM platforms, Windows, VMS and a variety of UNIX platforms. It provides a common programming interface (API) to which programs are written. It uses a message queuing approach that provides reliability by storing messages (in a message queue) until the target application is ready to accept the data. Thus, the messages do not have to be resent when for example the host of the target application is not operational. There is a need to extend the operation of messaging middleware across firewalls.

### SUMMARY OF THE INVENTION

A system for integrating applications in different enterprises separated by firewalls comprises: an input for receiving high level business data from a source application; an encryption engine for encrypting the business data to produce encrypted business data; a queue manager for receiving the encrypted business data and for storing the business data for delivery to a target application; and an output for transmitting the encrypted business data to the target application, wherein the system and the target application are separated by at least one firewall.

An application of the invention is realized by practicing a method for integrating applications hosted at different enterprises separated by at least one firewall. The method comprises steps of: receiving data from a source application program; encoding the data according to a message queuing protocol to provide an MQ (message queuing) message; encrypting the MQ message to provide an encrypted MQ message; and transmitting the encrypted MQ message to a destination application program for processing of the data.

Another application of the invention is realized by a computer readable medium comprising instructions for performing the above steps in a programmable information processing system or apparatus.

### BRIEF DESCRIPTION OF THE DRAWINGS

FIG. 1 is a block diagram illustration of a business process integration system according to a first embodiment of the present invention.

FIG. 2 is a block diagram illustration of a business process integration system according to a second embodiment of the present invention.

FIG. 3 is a high-level block diagram illustrating a system according to the invention.

FIG. 4 is a flow chart illustrating a method according to the invention.

### DETAILED DESCRIPTION

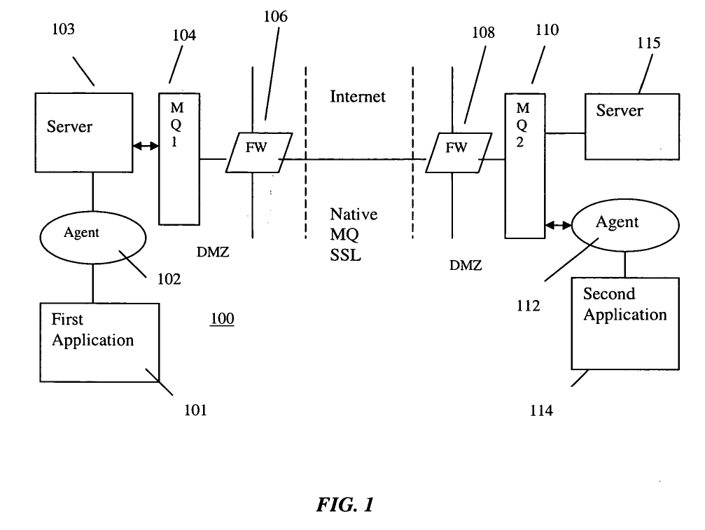

Referring to FIG. 1, there is shown a block diagram of a business process integration system 100 for integrating applications in different enterprises separated by firewalls according to an embodiment of the invention. The system 100 comprises a first application program 101 residing in a local area network (LAN). An agent 102 couples the first application 101 to a server 103 which acts as a hub for an enterprise application integration system. The agent 102 acts as an interface between the application 101 and the hub server 103 which processes data in a generic format that can be interfaced with other different applications via other agents (not shown). The server 103 interfaces with the first application 101 in a conventional manner. An MQ server (MQ1) 104 is disposed between the server 103 and a firewall 106 that separates the LAN from the Internet.

At the other end of the Internet a second firewall 108 protects a second LAN from actions by other nodes connected to the Internet. The firewall 108 is coupled to second MQ server (MQ2) 110. The MQ2 110 is in turn coupled to a server 115 and to an agent 112. The server 115 can also be used as an application integration hub for other different applications. The agent 112 is coupled to a second application 114.

According to the invention, agent 112 is used for receiving high level business data from a source application such as second application 114 and for transmitting the data for processing by a server (e.g., server 103) separated from the application 114 by the Internet. To ensure security, an encryption engine, possibly integrated into the agent, encrypts the business data to produce encrypted business data. The MQ server 110 acts as a queue manager for receiving the encrypted business data and for storing the business data for delivery to server 103 for processing the data when the target server 103 is ready to process the data.

The firewall 108 is used to filter out or block undesired messages from other nodes connected to the Internet. It can be a single router that filters out unwanted packets or may comprise a combination of routers and servers each performing some type of firewall processing. In this embodiment, the message originating from application 114 is encrypted using the secure sockets layer protocol.

As the encrypted message traverses the Internet it encounters a first demilitarized zone outside the firewall 108. This DMZ is a middle ground between the trusted internal network on one side of the firewall 108 and the untrusted, external network, such as the Internet in this case, on the other side.

The encrypted MQ message is then received at the other end of the Internet. At that end the message first encounters a firewall 106 guarding the local area network where the target server 103 is located. The firewall 106 has been programmed to allow passage of the message. The message is then relayed to queue manager 104 that decodes and decrypts the MQ message and passes it to the server 103 for processing. The server 103 is preferably at a hub of a hub-and-spoke middleware messaging system and the agents 102 and 112 are preferably configured as an adapter or spoke in the system. Adapters are written to interface between a generic hub having a well-known application program interface (API) and an enterprise application having a proprietary data structure scheme or semantics.

As an example, consider the case where the server 103 is hosted at a large enterprise warehouse and application 114 is hosted at a supplier for the warehouse. An order generated by the warehouse may not be compatible with its supplier's enterprise software 114. The middleware described herein integrates the different applications without the need to adapt one to the other. The use of message queuing provides the reliability of communications required by enterprise applications and the encryption provides the security that enables communication outside of a protected LAN.

Optionally, the agent 112 can be used for bookkeeping purposes to monitor messages being passed between the application 114 and the server 103. For example the agent 112 can send a message to the application 114 to stop sending messages so that it can perform the bookkeeping functions. The agent 112 can also keep a record of the type and number of messages that it processes.

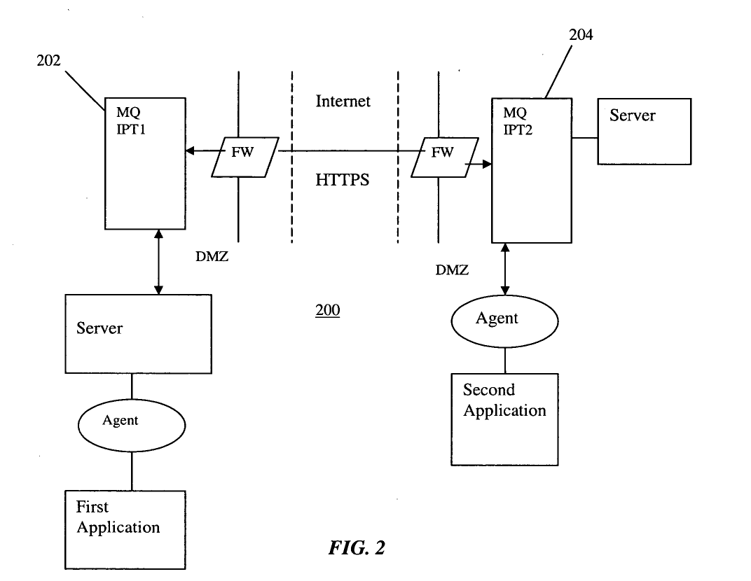

Referring to FIG. 2, a system 200 is substantially similar to the system 100 shown in FIG. 1, except that the MQ message is encrypted according to the HTTPS (HyperText Transport Protocol Secure) protocol. The HTTPS is the protocol for accessing a secure Web server. Using HTTPS in the URL (uniform resource locator) instead of HTTP directs the message to a secure port number rather than the default Web port number of 80. The session is then managed by a security protocol.

Using HTTP has the advantage that it can pass the normally available firewalls on Web servers. For more reliable messaging as provided by HTTP, MQ servers 202 and 204 use a reliable message queue system such as MQSeries Internet Passthrough (MQ IPT). MQ IPT also runs on top of the HTTP protocol and can therefore pass through firewalls. However, it also provides all the advantages which MQ messaging brings to applications.

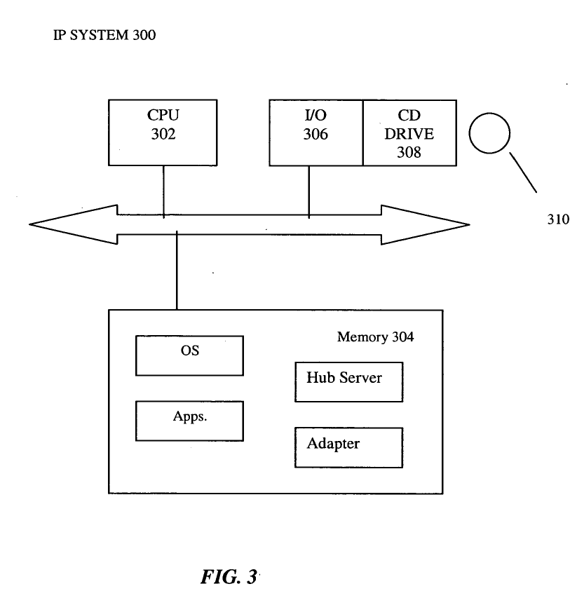

Referring to FIG. 3, there is shown a high level block diagram illustrating an information processing system 300 according to the invention. The system 300 can be programmed to operate as a server or agent or can host an application to be integrated with other enterprise applications. The system comprises a central processor unit 302, a memory 304, and an I/O subsystem 306. The memory comprises an operating system 312 (e.g., AIX or OS/2) and an application 314 (e.g., applications 102 or 114 of FIG. 1, which can be supply chain management, order fulfillment or other enterprise software). The system 300 further comprises a CD ROM or DVD drive 308 for receiving a CD ROM 310. The CD ROM 310 may comprise a program product comprising instructions for carrying out methods according to the invention. The CD ROM 310 preferably comprises a hub such as an interchange server and a plurality of adapters each for interfacing with a specific enterprise application. Alternatively, the information processing system 300 may comprise an application specific integrated circuit (ASIC) hardwired to operate according to an embodiment of the invention or a read-only memory may comprise the program instructions required to practice the invention.

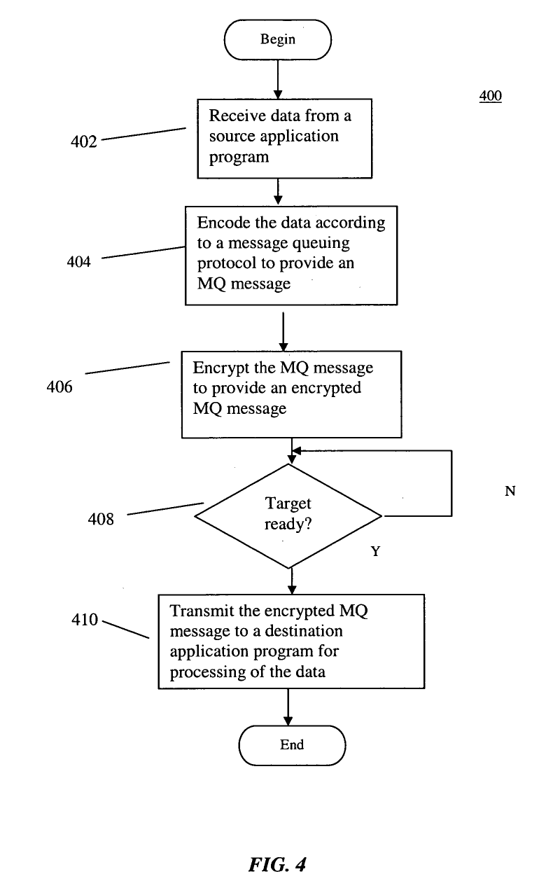

Referring to FIG. 4, there is shown a flow chart illustrating an information processing method 400 according to an embodiment of the invention. The method 400 comprises the following basic acts. In step 402 a remote agent or other information processing system according to the invention receives a message from an application 114. The message comprises high level data and a request to process the data by a server. In step 404 the system converts the message into an MQ message using a message queuing protocol. In step 406 the MQ message is encrypted using a security protocol to provide a secure MQ message. In decision 408 it is determined whether the packets of the message can be received by the target or destination node. If the target is ready to receive the packets the process continues at step 410. If the target is not ready then the message is stored until the target is ready to accept the message. Finally, in step 410 the MQ message is sent to a first queue manager for retransmission at a time when the network is ready for transporting the message to the target node.

Therefore, while there has been described what is presently considered to be the preferred embodiment, it will be understood by those skilled in the art that other modifications can be made within the spirit of the invention.

1. A system for integrating applications in different enterprises separated by firewalls, the system comprising:
an input for receiving high level business data from a source application;
an encryption engine for encrypting the business data to produce encrypted business data;
a queue manager for receiving the encrypted business data and for storing the business data for delivery to a target processor; and
an output for transmitting the encrypted business data to the target application, wherein the system and the target processor are separated by at least one firewall.

2. The system of claim 1, further comprising the at least one firewall for coupling the output to a wide area network.

3. The system of claim 1, wherein the encryption engine comprises a secure sockets layer protocol.

4. The system of claim 1, wherein the encryption engine comprises an HTTPS protocol.

5. A method for integrating applications hosted at different enterprises separated by at least one firewall, comprising steps of:
receiving data from a source application program;
encoding the data according to a message queuing protocol to provide an MQ message;
encrypting the MQ message to provide an encrypted MQ message; and
transmitting the encrypted MQ message to a destination application program for processing of the data.

6. The method of claim 5 further comprising storing the encrypted MQ message in a queue manager prior to transmitting the encrypted MQ message.

7. The method of claim 5 further comprising sending a message to the source application program instructing the source application program to stop sending data.

8. The method of claim 5 further comprising maintaining a record of the messages received from the source application program.

9. The method of claim 8 wherein the record of the messages received from the source application program comprises information on the number of messages received.

10. The method of claim 8 wherein the record of the messages received from the source application program comprises information on the type of messages received.

11. A computer readable medium comprising program instructions for receiving data from a source application program;
encoding the data according to a message queuing protocol to provide an MQ message;
encrypting the MQ message to provide an encrypted MQ message; and
transmitting the encrypted MQ message to a destination application program for processing of the data.

12. The computer readable medium of claim 11 further comprising an instruction for storing the encrypted MQ message in a queue manager prior to transmitting the encrypted MQ message.

13. The computer readable medium of claim 11 further comprising an instruction for sending a message to the source application program instructing the source application program to stop sending data.

14. The computer readable medium of claim 11 further comprising an instruction for maintaining a record of the messages received from the source application program.

15. The computer readable medium of claim 14 wherein the record of the messages received from the source application program comprises information on the number of messages received.

16. The computer readable medium of claim 14 wherein the record of the messages received from the source application program comprises information on the type of messages received.

17. A remote agent comprising:
an input for receiving a message from a first application, the message comprising high level data and a request to process the data by a second application at a target node in a network, wherein the target node is located at another side of a firewall from the agent; and
a first queue manager for receiving messages from the agent and for transmitting the messages to the target node when the target node can receive the messages.

18. A method for transmitting high-level data in real time to one or more enterprises, the method comprising:
receiving, from an application, a message comprising high level data and a request to process the data by a server;
converting the message into an MQ message using a message queuing protocol;
encrypting the MQ message using a security protocol to provide a secure MQ message; and
transmitting the MQ message to a first queue manager for retransmission at a time when the network is suitable for transporting the message to the server.

19. The method of claim 9, wherein the high level data comprises customer information

20. The method of claim 9, wherein transmitting the MQ message further comprises using a hypertext transfer protocol.

21. The method of claim 9, wherein transmitting the MQ message further comprises a secure socket layer protocol.

22. The method of claim 9, wherein transmitting the MQ message further comprises a hypertext transfer protocol over a secure socket layer.
